(19) United States
(12) Patent Application Publication
(10) Pub. No.: US 2017/0068922 A1
(43) Pub. Date: Mar. 9, 2017

(54) METHODS AND SYSTEMS FOR MANAGING SKILLS OF EMPLOYEES IN AN ORGANIZATION

(71) Applicant: XEROX CORPORATION, Norwalk, CT (US)

(72) Inventors: Atul Singh, Bangalore (IN); Arpita Biswas, Kolkata (IN); Gurulingesh Raravi, Bangalore (IN); Koyel Mukherjee, Bangalore (IN); Partha Dutta, Bangalore (IN); Raja Subramaniam Thangaraj, Kulilhalai (IN)

(21) Appl. No.: 14/844,019

(22) Filed: Sep. 3, 2015

(51) Int. Cl. G06Q 10/06; G06F 3/0482; G06F 3/0484

(52) U.S. Cl. CPC G06Q 10/063112; G06F 3/04842; G06F 3/0482

(57) ABSTRACT

According to embodiments illustrated herein, there is provided a method for training management in an organization. The method includes determining a skill gap in the organization, wherein the skill gap comprises one or more third skills, which are deficient in the organization. The method further includes recommending one or more trainings, corresponding to each of the one or more third skills, to an employee, from the one or more employees, based on at least a skill path or a motivational factor determined for the employee. The method further includes approving automatically the one or more trainings of at least one skill, from the one or more third skills, for the employee based on at least the skill gap, a preference of the employee for the one or more third skills, and the skill path of the one or more employees.

### TECHNICAL FIELD

The presently disclosed embodiments are related, in general, to a training management system. More particularly, the presently disclosed embodiments are related to methods and systems for managing skills of employees in an organization.

### BACKGROUND

With ever-increasing advancements in field of science and technology, companies/organizations are continuously exploring market/industry trends to expand their businesses/services. Further, in order to manage new businesses/services, the companies/organizations may require a work force with required skills. In one scenario, the companies/organizations may hire one or more new employees with the required skills, but this may lead to an increased cost of hiring new employees. In another scenario, the companies/organizations may train one or more existing employees on the required skills to create/generate the work force.

Usually, the companies/organizations may maintain an employee skill management system, which maintain a record of one or more skills of the one or more employees. However, the existing employee skill management system may not take into account new businesses/services/projects, industry trends, or employees staffing, while managing/scheduling training for the employees. Therefore, there is a need for a robust method and system to manage the one or more skills of the one or more employees.

### SUMMARY

According to embodiments illustrated herein, there is provided a method for training management in an organization. The method includes determining, by one or more processors, a skill gap in the organization based on at least one or more first skills required for processing one or more upcoming projects, and one or more second skills possessed by one or more employees in the organization, wherein the skill gap comprises one or more third skills, which are deficient in the organization. The method further includes determining, by the one or more processors, a skill path for each of the one or more employees based on at least the skill gap and the one or more second skills. The method further includes recommending, by the one or more processors, one or more third skills to an employee, from the one or more employees, based on at least the skill path associated with the employee. The method further includes approving, automatically by the one or more processors, one or more trainings corresponding to at least one skill, from the one or more third skills, for the employee based on at least the skill gap, a preference of the employee for the one or more third skills, and the skill path of the one or more employees.

According to embodiments illustrated herein, there is provided a system for training management in an organization. The system includes one or more processors configured to determine a skill gap in the organization based on at least one or more first skills required for processing one or more upcoming projects, and one or more second skills possessed by one or more employees in the organization, wherein the skill gap comprises one or more third skills, which are deficient in the organization. The one or more processors are further configured to determine a skill path for each of the one or more employees based on at least the skill gap and the one or more second skills. The one or more processors are further configured to recommend one or more third skills to an employee, from the one or more employees, based on at least a motivational factor associated with the one or more third skills for the employee. The one or more processors are further configured to approve automatically one or more trainings corresponding to least one skill, from the one or more third skills, for the employee based on at least the skill gap, a preference of the employee for the one or more third skills, and the skill path of the one or more employees.

According to embodiments illustrated herein, there is provided a computer program product for use with a computer. The computer program product includes a non-transitory computer readable medium. The non-transitory computer readable medium stores a computer program code for training management in an organization. The computer program code is executable by one or more processors configured to determine a skill gap in the organization based on at least one or more first skills required for processing one or more upcoming projects, and one or more second skills possessed by one or more employees in the organization, wherein the skill gap comprises one or more third skills, which are deficient in the organization. The computer program code is further executable by the one or more processors configured to determine a skill path for each of the one or more employees based on at least the skill gap and the one or more second skills. The computer program code is further executable by the one or more processors configured to recommend one or more third skills to an employee, from the one or more employees, based on at least a motivational factor associated with the one or more third skills for the employee. The computer program code is further executable by the one or more processors configured to approve automatically one or more trainings corresponding to least one skill, from the one or more third skills, for the employee based on at least the skill gap, a preference of the employee for the one or more third skills, and the skill path of the one or more employees.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating a system for training management in an organization, in accordance with at least one embodiment;

FIG. 3 is a flowchart illustrating a method for training management in an organization, in accordance with at least one embodiment;

FIG. 4A is a block diagram illustrating a graphical user interface (GUI) displaying skill gap in an organization, in accordance with an embodiment;

FIG. 4B is a block diagram illustrating a GUI utilized by a user to provide one or more parameters corresponding to the one or more training, in accordance with an embodiment;

FIG. 4C is a block diagram illustrating a GUI utilized by an employee to select his/her preferences among one or more third skills, in accordance with an embodiment;

FIG. 4D is a block diagram illustrating a GUI utilized by a user to approve preferences of one or more employees, in accordance with an embodiment; and

FIG. 4E is a block diagram illustrating a GUI utilized by a user to view/edit one or more approvals of one or more trainings, in accordance with an embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes one or more processors/microcontrollers and/or any other electronic components, or a device or a system that performs one or more operations according to one or more programming instructions/codes. Examples of the computing device may include, but are not limited to, a desktop computer, a laptop, a personal digital assistant (PDA), a mobile device, a Smartphone, a tablet computer (e.g., iPad®, and Samsung Galaxy Tab®), and the like.

An “organization” refers to a group of people, who may work together to achieve a predetermined goal. In an embodiment, the organization may include one or more teams that may further include one or more employees. Each of the one or more teams may have respective goals.

“One or more employees” refer to one or more individuals, who may have been hired by an organization, a company, or another individual to perform a project. In an embodiment, the one or more employees may perform or work upon the project in exchange for a compensation. In an embodiment, the one or more employees may possess one or more skills, which may not be utilized in the future (as the one or more skills may not be enough to attempt one or more upcoming projects).

A “user” refers to an individual who may utilize a computing device to perform one or more operations such as initiating training recommendations for one or more employees in an organization. In an embodiment, the user may include, but is not limited to, a supervisor, a manager, a project manager, a staffing manager, or a hiring manager associated with one or more projects in an organization.

A “project” refers to a piece of work, an activity, an action, a job, a service, an instruction or an assignment. In an embodiment, the project may be undertaken to create or modify a product, a service, or a result. In an embodiment, the project may be performed under one or more constraints such as a cost constraint or a time constraint. Further, the project may necessitate the involvement of one or more employees. Examples of the project may include, but are not limited to, generating a report, evaluating a document, conducting a survey, writing a code, extracting data, translating a text, and the like. Hereinafter, “project” and “task” may be interchangeably used.

“Training” refers to imparting knowledge or enhancing skills of an employee in a particular domain.

“Training management” refers to a management of one or more trainings pertaining to one or more skills required to process a project in an organization or an institution. In an embodiment, the training management may include one or more of, but not limited to, recommending trainings to one or more employees, receiving one or more requests to attend one or more trainings from an employee, approving the one or more requested trainings, and receiving one or more feedbacks pertaining to the one or more attended trainings, from the one or more employees.

“One or more skills” refer to one or more qualities or abilities possessed by an individual that may enable the individual to work upon an assignment, a task, or a project. In an embodiment, the individual may acquire/learn the one or more skills through a self-learning process. In another embodiment, the individual may acquire/learn the one or more skills by undergoing a set of training sessions provided by other individuals or an organization or a third party.

“One or more first skills” refer to a set of skills required for processing one or more upcoming/new/future projects in an organization. Therefore, the one or more first skills correspond to the set of skills that the employees of the organization need to possess in order to process the one or more future projects. For example, in order to process a future project, an organization may require 100 employees having C++ skill and 50 employees having Java skill. In such a case, the C++ and Java skills are first skills.

“One or more second skills” refer to a set of skills that are currently possessed by one or more employees in an organization. Further, a person skilled in the art will understand that each skill, from the one or more second skills, may be possessed by multiple employees in the organization. For example, 10 employees may possess C++ skill and five employees may possess Java skill. Therefore, the one or more second skills associated with the organization may include 10 employees with the C++ skill and five employees with the JAVA skill.

A skill gap refers to a number of employees that need to possess one or more first skills, in order to process a new project. For example, a new project requires 30 employees with Haskell skill and 25 employees with C# skill. Therefore, one or more first skills may be depicted as:
[Haskell, C#]=[30, 25]
   Further, for example, an organization comprises 20 employees with the Haskell skill and 18 employees with the C# skill. Therefore, one or more second skills may be depicted as:
[Haskell, C#]=[20, 18]
   A skill gap in the organization is depicted as:
[Haskell, C#]=[10, 7]

“One or more fourth skills” refer to a set of skills selected by an employee from one or more third skills, which may have been recommended to the employee. In an embodiment, the one or more employees may assign a priority to the one or more fourth skills based on at least his/her preferences, availability, and future scope. For example, a training management system recommends that an employee should attend training for either a C# skill or a Haskell skill or both. The employee selects the Haskell skill from the recommended skills. In such a case, the Haskell corresponds to a fourth skill.

A “skill path” refers to a learning path comprising one or more pre-requisite skills that may be required to learn one or more third skills. The one or more pre-requisite skills may be determined based on at least an ontology associated with each of the one or more third skills. For example, an employee possesses C++ skill. A new project requires the employee to learn a new skill such as Java. In such a case, ontology associated with the C++ skill to learn the Java skill will include object oriented concept. Thus, a skill path of the employee include C++→object oriented concept→Java. In an embodiment, the skill path may further define the order in which the one or more perquisites skills need to be learnt in order to learn a third skills. In an embodiment, the skill path may be determined for each of one or more employees of an organization.

“Ontology” refers to a graph that defines an inter-relationship of a skill with respect to other skills. In an embodiment, the ontology may be utilized to determine a skill path of an employee with one or more skills who may want to learn one or more new skills.

A “preference” refers to a fact or a condition of being treated or regarded as more important than others. In an embodiment, the preference may comprise one or more ratings such as, but not limited to, “high”, “medium”, or “low” assigned to one or more skills or trainings. In another embodiment, the preference may comprise one or more numerical values representing the one or more ratings such as, but not limited to, “1”, “2”, or “3”, wherein rating “1” may be assigned corresponding to a most important training/skill and rating “3” may be assigned corresponding to a least important training/skill, or vice versa. Hereinafter, “preference” and “priority” may be interchangeably used.

“Constructive learning” refers to a theory of learning, where learning may comprise constructing knowledge, related to one or more skills, based on personal experience. As per constructive theory of learning, an employee may easily learn a new skill using his/her past learning, which he/she may have developed or learned while practicing one or more existing skills. For example, it may be easy for an employee with C# skill to learn Java programming as he/she may utilize knowledge such as object oriented concepts that he/she may have developed while using C#.

“Motivational learning” refers to a theory of learning, where learning may include presenting a relevance of one or more skills to the employee in order to motivate an employee to acquire/learn the one or more skills. The relevance of the one or more third skills may be represented by a numerical score. In an embodiment, the numerical score may correspond to a motivational factor. For example, consider an employee with C++ skill and Java skill. Consider a new skill such as Haskell skill. In order to motivate the employee to learn the Haskell skill, a motivational factor is determined based on a count of employees having at least the C++ and Java skills but not the Haskell skill and a count of employees having at least C++, Java, and Haskell skill. For example, consider there are 100 employees with at least the C++ skill and the Java skill. These 100 employees do not possess the Haskell skill. Consider there are 200 employees with at least the C++, the Java, and the Haskell skill. Therefore, the motivational factor is 200/100 i.e. 2. This may imply that in every three employee, two employees possess the Haskell skill. Thus, it may be beneficial to learn the Haskell skill.

A “data structure” refers to a collection of data stored in a memory. In an embodiment, various operations may be performed to manipulate the data structures. Some examples of data structures may include, but are not limited to, a vector, a matrix, an array, a record, a hash table, a union, graphs, and linked list.

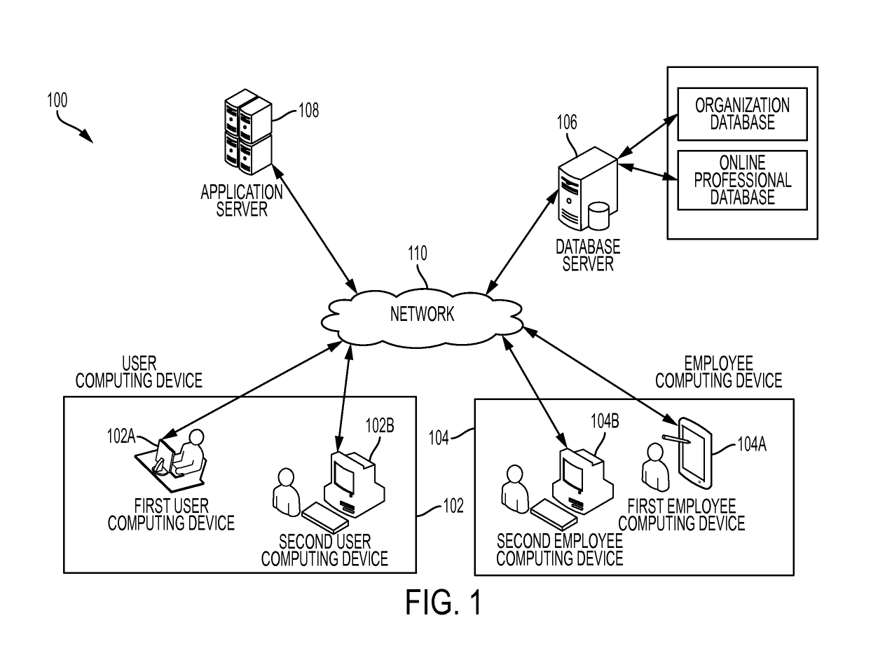

FIG. 1 is a block diagram illustrating a system environment 100 in which various embodiments may be implemented. The system environment 100 includes a user computing device 102 such as a first user computing device 102A and a second user computing device 102B, an employee computing device 104 such as a first employee computing device 104A and a second employee computing device 104B, a database server 106, an application server 108, and a network 110. Various devices in the system environment 100 may be interconnected over the network 110. FIG. 1 shows, for simplicity, two user computing devices 102A and 102B, two employee computing devices 104A and 104B, one database server 106 and one application server 108. However, it will be apparent to a person having ordinary skill in the art that the disclosed embodiments may also be implemented using multiple user computing devices, multiple employee computing devices, multiple database servers, and multiple application servers without departing from the scope of the disclosure.

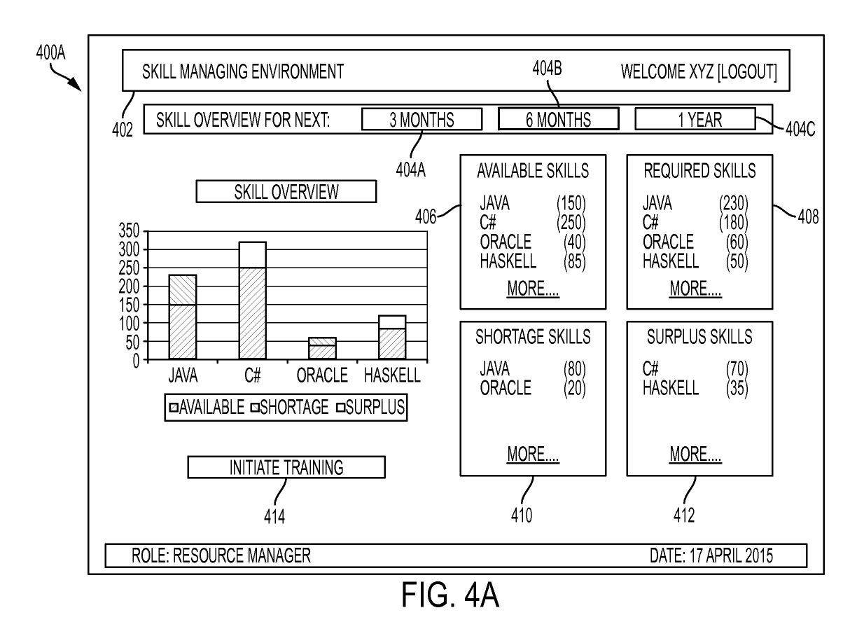

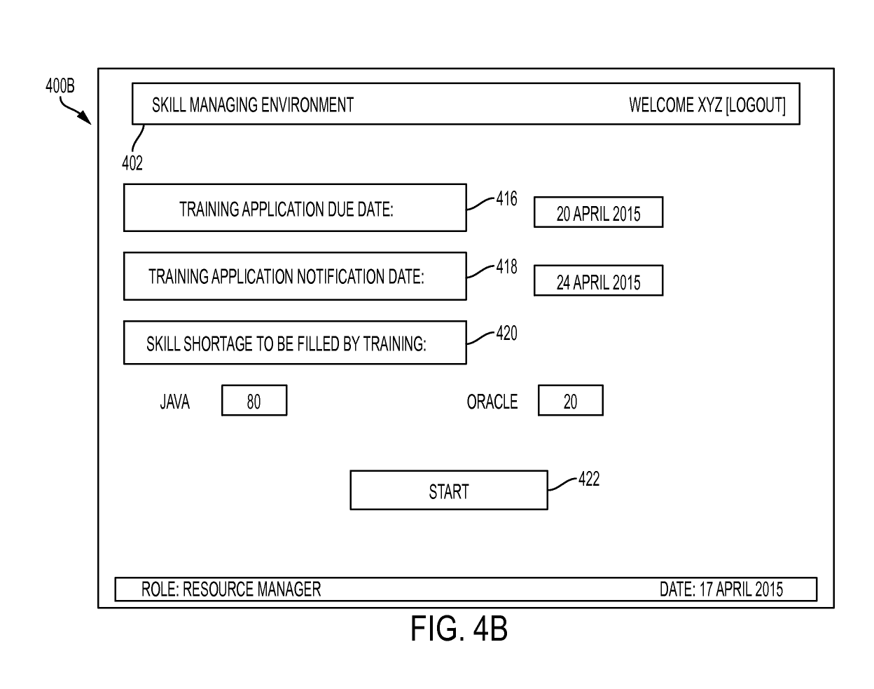

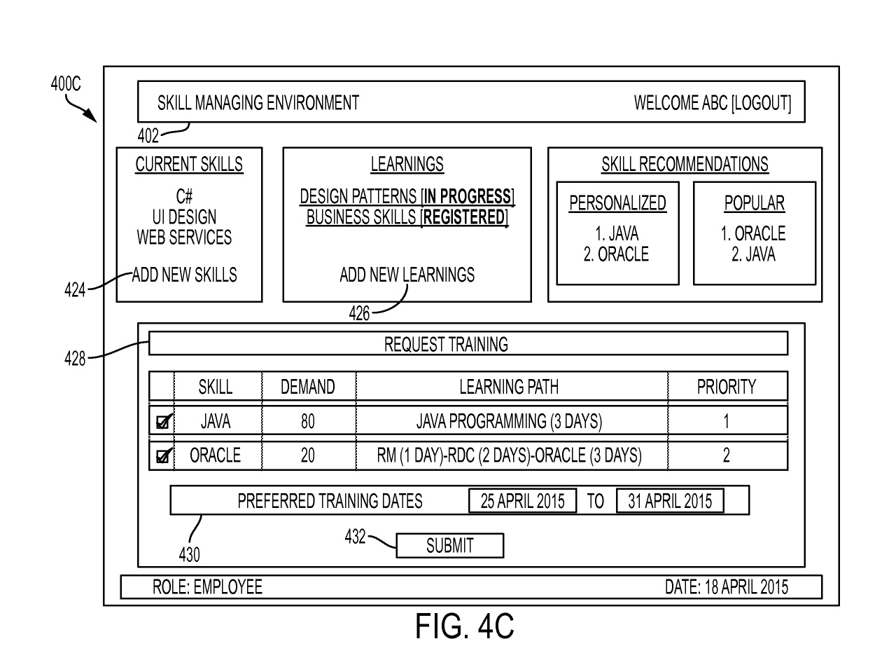

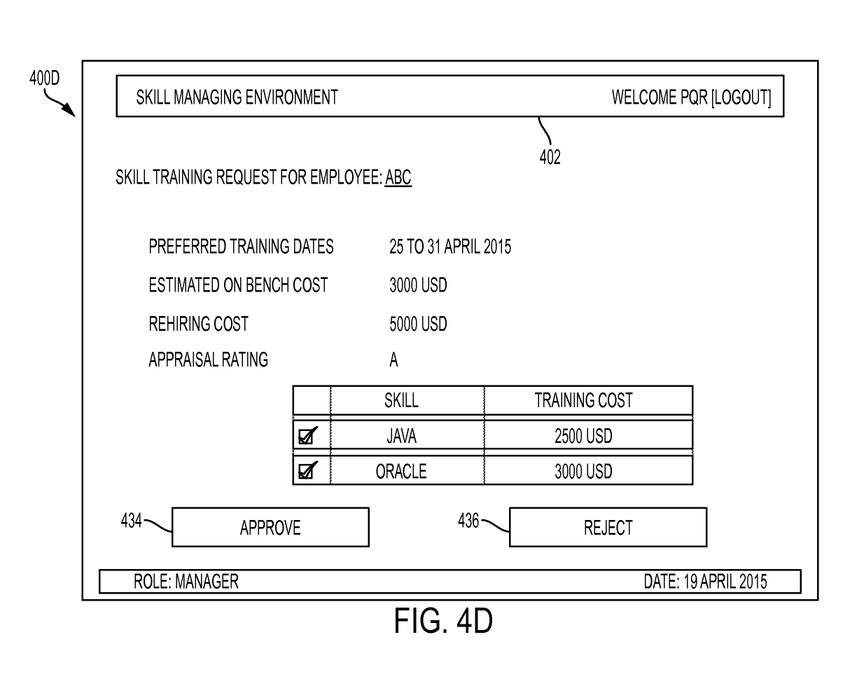

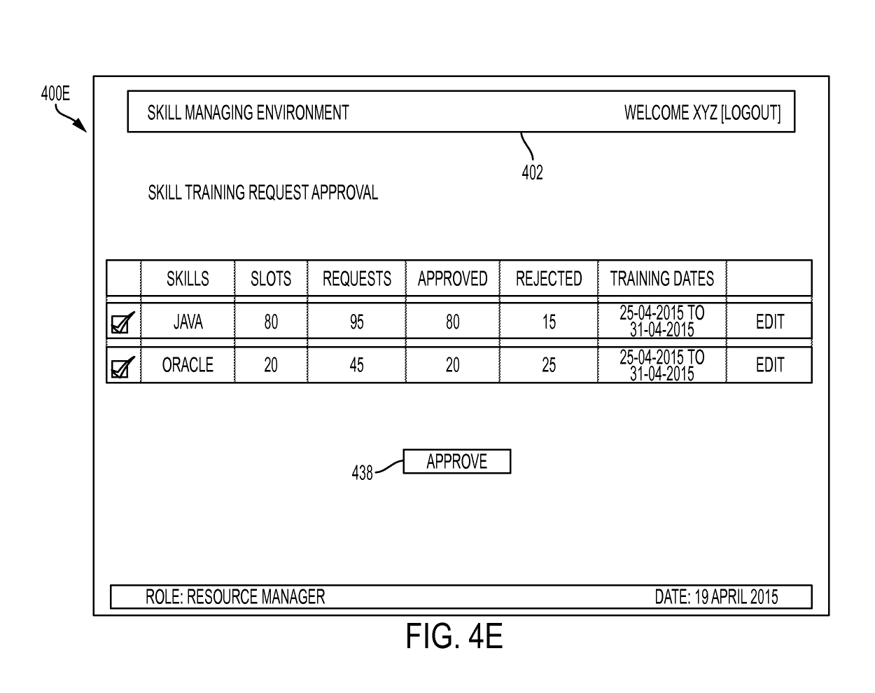

The user computing device 102 refers to a computing device used by a user in an organization. In an embodiment, the user may correspond to at least one of, but is not limited to, a supervisor, a manager, a project manager, a staffing manager, a resource manager, and a hiring manager. The user computing device 102 may comprise one or more processors in communication with one or more memories. The user computing device 102 may be operable to execute one or more sets of instructions stored in the one or more memories. In an embodiment, the user computing device 102 may be communicatively coupled to the network 110. In an embodiment, the user computing device 102 may comprise a display screen that may be configured to display one or more graphical user interfaces (GUIs) to the user. In an embodiment, the user may utilize the user computing device 102 to input metadata associated with one or more upcoming projects. For example, a resource manager may utilize the user computing device 102 to input one or more first skills. The one or more first skills may correspond to a set of skills, which are required for processing the one or more upcoming projects. In an embodiment, the user may utilize the user computing device 102 to provide an input to initiate a recommendation of one or more third skills to one or more employees. The one or more third skills may correspond to a set of skills, which are deficient in the organization. In an embodiment, the recommendation of the one or more third skills may further correspond to the recommendation of one or more trainings associated with the one or more third skills. The user may utilize a GUI, presented on the display screen of the user computing device 102, to input one or more parameters corresponding to the one or more trainings. For example, a staffing manager may input a due date for a training application, a notification date for the training application, and a count of employees required for one or more third skills, which are deficient in an organization. Further, the user may utilize the user computing device 102 to view/edit one or more trainings requested by the one or more employees. For example, a project manager may view one or more trainings requested by an employee. Further, the project manager may approve or reject the request to attend the one or more trainings. Further, in an embodiment, the user (e.g., the resource manager) may utilize the user computing device 102 to view the one or more requested trainings approved or rejected by the project manager or the application server 108. Thereafter, the user may modify approvals or rejections of the one or more requested trainings corresponding to the one or more employees. Further, the staffing manager may provide an input to finalize the one or more requested trainings of the one or more employees. The one or more GUIs utilized by the user to provide one or more inputs to perform one or more operations have been described later in conjunction with FIGS. 4A-4B and FIGS. 4D-4E.

The user computing device 102 may include various types of computing devices such as, but not limited to, a desktop computer, a laptop, a personal digital assistant (PDA), a mobile device, a Smartphone, a tablet computer (e.g., iPad® and Samsung Galaxy Tab®), and the like.

The employee computing device 104 may correspond to a computing device that may be operable to execute one or more sets of instructions stored in one or more memories. The employee computing device 104 may comprise one or more processors in communication with the one or more memories. In an embodiment, the employee computing device 104 may be communicatively coupled to the network 110. In an embodiment, the employee computing device 104 may be utilized by the one or more employees. In an embodiment, the one or more employees may correspond to one or more individuals, who may have been hired by the organization to work upon one or more projects. In an embodiment, the employee computing device 104 may comprise a display screen that may be configured to display one or more graphical user interfaces (GUIs) to the one or more employees. In an embodiment, the one or more employees may utilize a GUI to view and/or edit one or more second skills. In an embodiment, the one or more second skills may correspond to a set of skills, which are currently possessed by an employee. In an embodiment, the one or more employees may utilize the GUI on the display screen of the employee computing device 104 to view the recommendations of the one or more third skills. In an embodiment, the recommendation of the one or more third skills is received from the application server 108. The one or more employees may utilize the GUI to select one or more fourth skills, from the one or more third skills, and further may assign a priority to each of the one or more fourth skills based on at least his/her preferences, availability, and future scope of the one or more fourth skills. Further, the one or more employees may provide a request for one or more trainings, pertaining to the one or more fourth skills, based on at least the assigned priority.

In an embodiment, the employee computing device 104 may correspond to various types of computing devices such as, but not limited to, a desktop computer, a laptop, a personal digital assistant (PDA), a mobile device, a Smartphone, a tablet computer (e.g., iPad® and Samsung Galaxy Tab®), and the like.

The database server 106 may refer to a computing device that may be communicatively coupled over the network 110. In an embodiment, the database server 106 may store the metadata associated with the one or more upcoming projects. The metadata may include the one or more first skills that may be required to process the one or more upcoming projects. Further, the database server 106 may store one or more attributes associated with the one or more employees. In an embodiment, the one or more attributes associated with each employee may include, but are not limited to, the one or more second skills, previous appraisal ratings, salary details, and performance of the each employee on one or more previous projects.

Further, in an embodiment, the database server 106 may be communicatively coupled with databases of other organizations and online professional databases (e.g., LinkedIn and Github). The database server 106, with rightful authentication, may extract and store skill information of employees associated with at least one of the other organizations and the online professional databases.

Further, in an embodiment, the database server 106 may be configured to transmit or receive one or more instructions/queries to/from one or more devices, such as the user computing device 102 and the application server 108 over the network 110. In an embodiment, the database server 106 may receive a query from the application server 108 to retrieve the metadata associated with the one or more upcoming projects and the one or more attributes associated with the one or more employees. For querying the database server 106, one or more querying languages may be utilized such as, but are not limited to, SQL, QUEL, DMX and so forth. Further, the database server 106 may be realized through various technologies such as, but not limited to, Microsoft® SQL server, Oracle, and My SQL.

The application server 108 may refer to a computing device or a software framework that may provide a generalized approach to create the application-server implementation. In an embodiment, the function of the application server 108 may be dedicated to the efficient execution of procedures such as, but not limited to, programs, routines, or scripts stored in the one or more memories for supporting its applied applications. Post receiving the input from the user pertaining to the initiation of the recommendation of the one or more third skills, the application server 108 may extract the one or more first skills associated with the one or more upcoming projects and the one or more second skills associated with the one or more employees. Thereafter, the application server 108 may determine a skill gap based on at least the one or more first skills and the one or more second skills. The skill gap may comprise the one or more third skills, which are deficient in the organization. The skill gap may imply that the one or more employees of the organization do not possess the one or more third skills. In an embodiment, the skill gap may include information such as a count of employees required for each of the one or more third skills. In an embodiment, the one or more third skills may include the one or more first skills. For example, an organization has 10 employees having C# skill. Further, the organization requires 15 employees with the C# skill. Therefore, the organization has a deficient of 5 employees in the C# skill. Further, the C# skill is present in the one or more third skill. In an embodiment, the deficiency of the one or more third skills may imply that the one or more employees of the organization do not possess the one or more third skills, which may be required to process the one or more upcoming projects. Post determining the skill gap, the application server 108 may be configured to determine a skill path for each of the one or more employees, in the organization, based on the one or more third skills and the one or more second skills currently possessed by the one or more employees. In an embodiment, the skill path may correspond to a learning path that each employee may need to follow in order to learn at least one third skill. Further, the application server 108 may determine a motivational factor, pertaining to each third skill, for each of the one or more employees. The motivational factor corresponds to a numerical score that may be utilized to motivate the one or more employees to take up the one or more trainings pertaining to the one or more third skills. Thereafter, the application server 108 may recommend the one or more third skills to the one or more employees of the organization. The recommendation of the one or more third skills may be based on at least one of the skill path or the motivational factor.

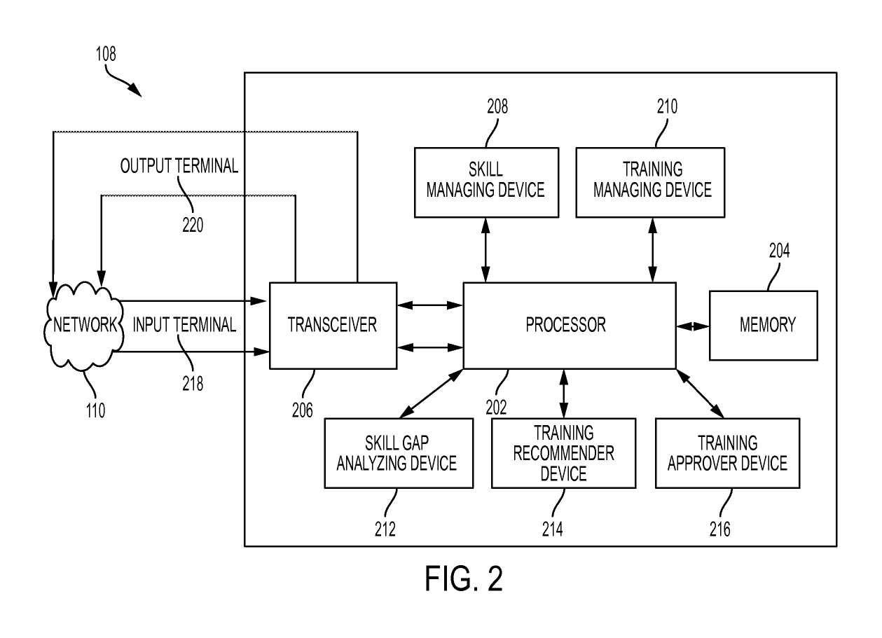

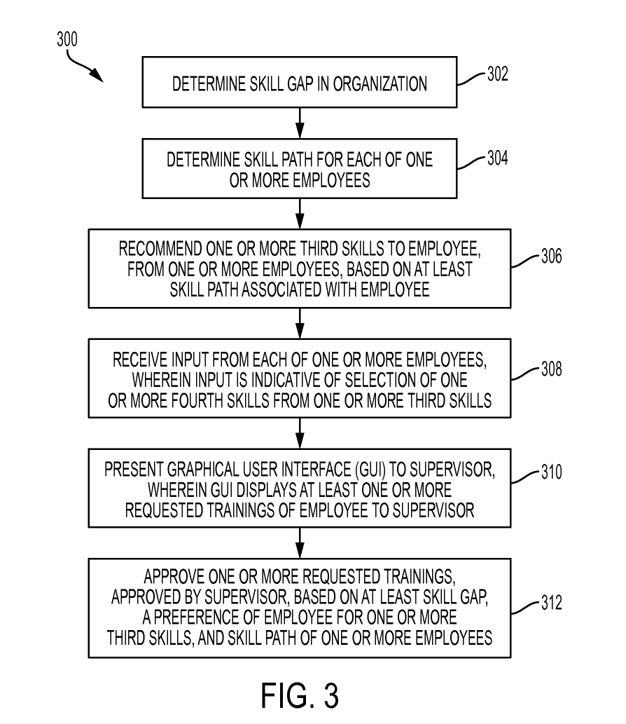

Post recommending the one or more third skills, the application server 108 may receive an input from the one or more employees. In an embodiment, the input may be indicative of selection of the one or more fourth skills from the one or more third skills. Further, the input may be indicative of selection of the one or more trainings pertaining to the one or more fourth skills. Thereafter, the application server 108 may present a GUI to the user (e.g., a supervisor, a project manager, or a manager) displaying the one or more trainings requested by the one or more employees. The application server 108 may receive one or more approvals, pertaining to the one or more trainings requested by the one or more employees, from the supervisor. Post approval from the supervisor, the application server 108 may automatically approve the one or more trainings pertaining to at least one skill, from the one or more fourth skills, for the one or more employees. In an embodiment, the application server 108 may approve the one or more trainings requested by an employee, post approval from the supervisor, based on at least the skill gap, the preference of the employee for the one or more third skills, and the skill path of the one or more employees. The approval of the one or more trainings requested by the one or more employees has been described later in conjunction with FIG. 2 and FIG. 3.

The application server 108 may be realized using various technologies such as, but not limited to, Java application server, .NET Framework, PHP, Base4 application server, and Appaserver. The application server 108 has been described later in conjunction with FIG. 2.

A person skilled in the art will understand that the scope of the disclosure is not limited to the database server 106 or the application server 108 as a separate entity. In an embodiment, the functionalities of the database server 106 and the application server 108 may be combined into a single server, without limiting the scope of the disclosure.

A person skilled in the art will understand that the scope of the disclosure is not limited to the user computing device 102 and the application server 108 as separate entities. In an embodiment, the application server 108 may be realized as an application hosted on or running on the user computing device 102 without departing from the spirit of the disclosure.

The network 110 corresponds to a medium through which data (e.g., the metadata associated with the one or more upcoming projects, the one or more attributes associated with the one or more employees, etc.) may flow between one or more of, but not limited to, the user computing device 102, employee computing device 104, the database server 106, and the application server 108. Examples of the network 110 may include, but are not limited to, a Wireless Fidelity (Wi-Fi) network, a Wide Area Network (WAN), a Local Area Network (LAN), or a Metropolitan Area Network (MAN). Various devices such as the user computing device 102, employee computing device 104, the database server 106, and the application server 108 may connect to the network 110 in accordance with various wired and wireless communication protocols such as Transmission Control Protocol/Internet Protocol (TCP/IP), User Datagram Protocol (UDP), and 2G, 3G, or 4G communication protocols. Further, various devices such as the user computing device 102, employee computing device 104, the database server 106, and the application server 108 may connect to the network 110 by utilizing different devices and services such as, but not limited to, a mobile internet, a data card, an internet dongle, a broadband, a wireless internet, hotspots, a dial-up connection, DSL (digital subscriber line), a satellite, ISDN (integrated services digital network), optical carrier, and T-carrier.

FIG. 2 is a block diagram illustrating a system 108 for training management in an organization, in accordance with at least one embodiment. The system 108 may comprise one or more processors, such as a processor 202, one or more memories, such as a memory 204, and one or more transceivers, such as a transceiver 206. The transceiver 206 is coupled to an input terminal 218 and an output terminal 220. Further, the system 108 may comprise a skill managing device 208, a training managing device 210, a skill gap analyzing device 212, a training recommender device 214, and a training approver device 216. In an embodiment, the skill managing device 208, the training managing device 210, the skill gap analyzing device 212, the training recommender device 214, and the training approver device 216 may be coupled to the processor 202.

The processor 202 may be configured to execute a set of instructions stored in the memory 204. The processor 202 may be coupled to the memory 204, the transceiver 206, the skill managing device 208, the training managing device 210, the skill gap analyzing device 212, the training recommender device 214, and the training approver device 216. In an embodiment, the processor 202 may be configured to perform one or more operations of the skill managing device 208, the training managing device 210, the skill gap analyzing device 212, the training recommender device 214, and the training approver device 216 without departing from the scope of the disclosure. The processor 202 may further comprise an arithmetic logic unit (not shown) and a control unit (not shown). The arithmetic logic unit (ALU) may be coupled to the control unit. The ALU may be operable to perform one or more mathematical and logical operations and the control unit may control the operation of the ALU. The processor 202 may execute a set of instructions/programs/codes/scripts stored in the memory 204 to perform the one or more operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store one or more sets of instructions. In an embodiment, the memory 204 may include one or more buffers (not shown). The one or more buffers may store the metadata associated with the one or more upcoming projects and the one or more attributes associated with the one or more employees. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 may enable the hardware of the system 108 to perform the one or more operation.

The transceiver 206 may be operable to communicate with the one or more devices, such as the user computing device 102 and the employee computing device 104 and/or one or more servers, such as the database server 106 over the network 110. The transceiver 206 may be operable to transmit and receive the metadata, the one or more attributes, content, information, queries, instructions, one or more responses pertaining to the one or more inputs, etc., to/from various components of the system environment 100. In an embodiment, the transceiver 206 is coupled to the input terminal 218 and the output terminal 220 through which the transceiver 206 may receive and transmit the metadata/one or more attributes/instructions, respectively. In an embodiment, the input terminal 218 and the output terminal 220 may be realized through, but not limited to, an antenna, an Ethernet port, an USB port or any other port that can be configured to receive and transmit data. The transceiver 206 may transmit and receive in accordance with various communication protocols such as, TCP/IP, UDP, and 2G, 3G, or 4G communication protocols through the input terminal 218 and the output terminal 220.

The skill managing device 208 may comprise suitable logic, circuitry, interfaces, and/or code that may be configured to extract skill records of the one or more employees from the database server 106. The skill records may include the one or more second skills, which are currently possessed by the one or more employees in the organization. In another embodiment, the skill managing device 208 may extract the skills records of the one or more employees from one or more professional social networks such as LinkedIn. Post extracting the skill records, the skill managing device 208 may store the skill records of the one or more employees in the database server 106 or the memory 204. In another embodiment, the skill managing device 208 may maintain a record of a count of employees with a particular second skill in the organization. For example, there are 100 employees with C++ skill and 180 employees with Haskell skill in an organization. In an embodiment, the skill managing device 208 may be configured to update the skill records of each of the one or more employees with one or more fourth skills, which may be taken up by each of the one or more employees in the future. In an embodiment, the skill managing device 208 may update the skill records of the one or more employees after a predefined time period such as, but not limited to, three months, six months, and so on.

A person having ordinary skills in the art will understand that the functionalities of the skill managing device 208 may be realized using the one or more processors such as the processor 202 without departing from the scope of the disclosure.

The training managing device 210 may comprise suitable logic, circuitry, interfaces, and/or code that may be configured to maintain and update training records of the one or more employees in the organization. In an embodiment, the training managing device 210 may keep a record of trainings, which may have been taken up by the one or more employees in the past. Further, in an embodiment, the training managing device 210 may be configured to update the training records of each of the one or more employees based on at least the one or more trainings, which may have been assigned to each of the one or more employees. In an embodiment, the training managing device 210 may update the training records of the one or more employees after a predefined time period such as, but not limited to, three months, six months, and so on.

A person having ordinary skills in the art will understand that the functionalities of the training managing device 210 may be realized using the one or more processors such as the processor 202 without departing from the scope of the disclosure.

The skill gap analyzing device 212 may comprise suitable logic, circuitry, interfaces, and/or code that may be configured to determine the skill gap in the organization. In an embodiment, the skill gap analyzing device 212 may keep a record of the one or more upcoming projects and one or more existing projects. The one or more upcoming projects may correspond to one or more new/future projects. The one or more existing projects may correspond to one or more completed projects and/or one or more ongoing projects. In an embodiment, the skill gap analyzing device 212 may utilize the record of the one or more existing projects and the one or more upcoming projects to determine the skill gap in the organizations. In an embodiment, the skill gap analyzing device 212 may utilize the one or more second skills, currently possessed by the one or more employees of the organization, and the one or more first skills, required to process the one or more upcoming projects, to determine the skill gap in the organization. The skill gap may include the one or more third skills, which are deficient in the organization. The determination of the skill gap has been explained later in conjunction with FIG. 3.

A person having ordinary skills in the art will understand that the functionalities of the skill gap analyzing device 212 may be realized using the one or more processors such as the processor 202 without departing from the scope of the disclosure.

The training recommender device 214 may comprise suitable logic, circuitry, interfaces, and/or code that may be configured to recommend the one or more third skills to the one or more employees. Further, in an embodiment, the training recommender device 214 may recommend the one or more trainings, pertaining to the one or more third skills, to the one or more employees. The recommendation may be a personalized recommendation and/or a popular recommendation. The personalized recommendation and the popular recommendation have been described later in conjunction with FIG. 3.

A person having ordinary skills in the art will understand that the functionalities of the training recommender device 214 may be realized using the one or more processors such as the processor 202 without departing from the scope of the disclosure.

The training approver device 216 may comprise suitable logic, circuitry, interfaces, and/or code that may be configured to approve the one or more trainings requested by the one or more employees. Post approval from the user (e.g., the supervisor, the project manager, or the manager), the training approver device 216 may automatically approve the one or more trainings based on at least the skill gap, the preferences of the one or more employees for the one or more trainings, and the skill path of each of the one or more employees.

A person having ordinary skills in the art will understand that the functionalities of the training approver device 216 may be realized using the one or more processors such as the processor 202 without departing from the scope of the disclosure.

FIG. 3 is a flowchart 300 illustrating a method for training management in an organization, in accordance with at least one embodiment. The flowchart 300 is described in conjunction with FIG. 1 and FIG. 2.

At step 302, the skill gap is determined for the organization. In an embodiment, the processor 202 may utilize the skill gap analyzing device 212 to determine the skill gap in the organization. In order to determine the skill gap, the skill gap analyzing device 212 may determine the one or more first skills and the one or more second skills.

In an embodiment, in order to determine the one or more first skills, the skill gap analyzing device 212 may receive or extract the metadata associated with the one or more upcoming projects from the user computing device 102 or the database server 106. The metadata may comprise the one or more first skills, which are required to process the one or more upcoming projects. The metadata may further comprise the count of employees required for each of the one or more first skills in order to process the upcoming projects within stipulated time. Thereafter, in an embodiment, the skill analyzing device 212 may determine a first data structure based on the count of employees pertaining to each of the one or more first skills. The first data structure, pertaining to the each upcoming project, may comprise at least one row and one or more columns. The at least one row may be representative of the count of employees and the one or more columns may be representative of the one or more first skills required for processing the each upcoming project.

For example, there is an upcoming project, which requires four skills namely C++, Haskell, Java, and C#. The number of employees required for each skill is 20, 15, 30, and 40, respectively. In such a case, the skill gap analyzing device 212 may determine a first data structure as shown below:

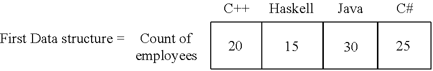

After determining the first data structure, the skill gap analyzing device 212 may extract the one or more second skills, which are currently possessed by the one or more employees in the organization, from the database server 106 or the memory 204. In another embodiment, the skill gap analyzing device 212 may utilize the skill managing device 208 to extract the one or more second skills of the one or more employees from the one or more professional social networks such as LinkedIn. Further, in an embodiment, the skill gap analyzing device 212 may determine a second data structure based on the count of the one or more employees, who are currently possessing the one or more second skills. The second data structure may comprise at least one row and one or more columns. The at least one row may be representative of the count of the one or more employees and the one or more columns may be representative of the one or more second skills currently possessed by the one or more employees. For example, an organization has 100 employees. Out of 100 employees, the organization has 30 employee with C++ skill, 10 employees with Haskell skill and 60 employees with C# skill. In such a case, the skill gap analyzing device 212 may determine a second data structure as shown below:

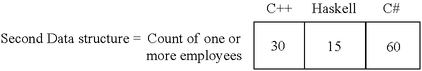

Post determining the first data structure and the second data structure, me skill gap analyzing device 212 may determine the skill gap based on at least the first data structure and the second data structure. In an embodiment, the skill gap analyzing device 212 may subtract the second data structure from the first data structure to obtain the skill gap in the organization. The skill gap may include information such as the count of employees which are required for each of the one or more third skills. In another embodiment, the skill gap may include at least one third skill which is not possessed by any of the one or more employees in the organization. Further, the skill gap may include the one or more third skills that are possessed by the some of the employees in the organization, but the required number of employees for the one or more third skills is more than the count of employees who possess the one or more third skills. Further, in an embodiment, the skill gap may be represented by a data structure that may include a count of employees pertaining to each third skill that are required to process the each upcoming project. Considering the ongoing example, the skill gap analyzing device 212 may determine a skill gap as shown below:

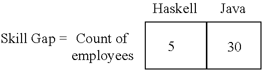

At step 304, the skill path is determined for each of the one or more employees in the organization. In an embodiment, the processor 202 may determine the learning path for each employee and for each third skill. The skill path may correspond to the learning path comprising one or more pre-requisite skills that each employee may follow in order to learn/master the one or more third skills. In an embodiment, the processor 202 may determine the skill path, for the each employee, based on at least the one or more second skills currently possessed by the each employee and the one or more third skills. For example, an employee possesses a second skill such as C# skill. The employee wants to learn Java skill. In such a case, the employee may have to learn object oriented concepts before learning the Java skill. Further, for each employee, the processor 202 may determine skill path for each of the one or more third skills that are not possessed by the each employee. For example, an employee possesses a C# skill. The one or more third skill determined at step 302 comprise Java skill and Haskell skill. The processor 202 may determine a skill path from C# skill to Java skill and a skill path from C# skill to Haskell skill. Therefore, multiple skill paths may be determined for each of the one or more employees depending on the one or more second skills possessed by each of the one or more employees. Further, a person having ordinary skills in the art will understand that the skill path for each of the one or more employees may be different and may depend on the current skills possessed by each of the one or more employees. For example, a first employee possesses skill-1 and a second employee possesses skill-2. The first employee and the second employee wants to learn a new skill such as skill-3. In such a case, the first employee may need to learn sub-skill-1 and sub-skill-2 before learning the skill-3 and the second employee may need to learn sub-skill-3, sub-skill-4, and sub-skill-5 before learning skill-3. Therefore, the skill path of the first employee and the second employee may represented as shown in Table1.

TABLE 1
Skill path of First employee and Second employee

| Skill path (First Employee) | Skill path (Second Employee) |
|---|---|
| skill-1→sub-skill-1→sub-skill- | skill-1→sub-skill-3→sub-skill-4→ |
| 2→skill-3 | sub-skill-5→skill-3 |

As shown in Table 1, the skill-1 and the skill-2 may correspond to second skills and the skill-3 may correspond to a third skill. Further, the sub-skill-1 and the sub-skill-2 may correspond to pre-requisites skills that the first employee may be required to learn so as to learn the skill-3. Similarly, sub-skill-3, sub-skill-4, and sub-skill-5 may correspond to the pre-requisites skills that the second employee may be required to learn so as to learn the skill-3. In an embodiment, the one or more pre-requisite skills may be determined based on at least an ontology associated with the one or more second skills to learn the one or more third skills. For example, an employee skilled in Haskell may need to learn Declarative Programming and then Object Oriented Programming (OOP) before he/she may learn Java. In an embodiment, the ontology used for the skill path may be created and modified using an existing ontology editor such as Protégé. In another embodiment, the processor 202 may create ontology based on at least a training curriculum of the organization, when courses for a third skill may include the one or more pre-requisite skills.

At step 306, the one or more third skills are recommended to the employee, from the one or more employees, based on at least the skill path associated with the employee. In an embodiment, the processor 202 may utilize the training recommender device 214 to recommend the one or more third skills to the employee. The training recommender device 214 may utilize a constructive theory of learning or a motivational theory of learning to recommend the one or more trainings associated with the one or more third skills. The recommendation of the one or more third skills based on the constructive theory of learning has been referred to as a personalized recommendation. The recommendation of the one or more third skills based on the motivational theory of learning has been referred to as a personalized recommendation.

The constructive theory of learning may correspond to a learning, which may involve constructing knowledge based on personal experience. For example, an employee with one or more second skills may develop or learn one or more sub-skills, while practicing the one or more second skills, that may be utilized later to develop or learn a third skill. For example, an employee with C# skill may have developed or learn an object oriented concept while practicing/using C#. The object oriented concept may further be utilized to learn a new skill such as Java. In such a scenario, the training recommender device 214 may utilize such a learning (i.e., the constructive theory of learning) of the one or more second skills by the employee to generate the skill path for the employee. In an embodiment, the skill path of the employee with the one or more second skills may comprise one or more learning paths, where the employee may follow each learning path to learn each third skill from the one or more third skills. In an embodiment, the training recommender device 214 may utilize a learning path algorithm to select one or more personalized learning paths from the one or more learning paths. The one or more personalized learning paths may be selected based on at least a shortest path between the one or more second skills and the one or more third skills. For example, an employee possesses a declarative programming skill. A new project requires Java skill and C skill. The skill path of the employee comprises two learning paths as shown in Table 2. In such a case, the training recommender device 214 may select a personalized learning path, from the two learning paths, based on the time duration associated with each learning path. For example, as shown in Table 2, the time duration associated with the first learning path is 7 days and the time duration associated with the second learning path is 5 days. In such a case, the training recommender device 214 may select the second learning path as the personalized learning path and thereafter, may recommend the C skill to the employee. In another embodiment, the training recommender device 214 may utilize other factors such as cost associated with each learning path to select the personalized learning paths from the one or more learning paths.

TABLE 2
Learning paths

| First learning path | Second learning path |
|---|---|
| Declarative Programming→ OOP | Declarative Programming→ |
| Concepts (2 days)→ Java (5 days) | Structural Programming |
| | (2 days)→ C (3 days) |

In an embodiment, the learning path algorithm may be realized using one or more pseudo-codes. For example, a pseudo-code that may be utilized to determine a personalized learning path is represented as under:

Input: one or more second skills of an employee (ES). One or more third skills (NS).
Output: Personalized learning path (LP)
1. LP=NULL
2. For each skill s in ES
3. Find shortest path (SP) between S and NS
4. If (LP==NULL∥effort (SP)<effort (LP)) then
5. LP=SP
6. End if
7. End for
8. Return LP

In another embodiment, the processor 202 may recommend the one or more third skills to the employee based on at least a motivational theory of learning. Such a recommendation has been referred to as the popular recommendation. The motivational theory of learning may be utilized to indicate about a relevance of the one or more third skills, which may motivate the employee to learn/master the one or more third skills. The processor 202 (and/or the training recommender device 214) may utilize one or more algorithms based on at least one of a Bayesian network and a memory based collaborative filtering to generate the popular recommendation.

### Bayesian Network Based Recommendation:

In Bayesian network based recommendation, the processor 202 may determine the motivational factor, corresponding to each of the one or more third skills, for the employee. The motivational factor may be representative of the numerical score that may be utilized to motivate the employee to take up the one or more trainings associated with the one or more third skills. The motivational factor, corresponding to each third skill, for the employee may be determined based on at least a first count of employees having the one or more second skills and a second count of employees having the one or more second skills and at least one third skill. For example, consider an employee (i=1) in an organization with a skill set as Sₑ. Further, consider a skill gap in the organization as S_{g}={S₁, . . . , Sₙ}. The processor 202 may utilize the following equation to determine a motivational factor (M₁) corresponding to a third skill (S₁) for the employee (i=1):

$${M}_{1} = \frac{{N}_{{S}_{1} + {S}_{e}}}{{N}_{{S}_{e}}} \qquad ( 1 )$$

wherein,

N_{S}_{₁}_{+S}_{ₑ}: Count of employees having skill S₁+Sₑ; and

N_{S}_{ₑ}: Count of employees having skill Sₑ.

Similarly, the processor 202 may determine the motivational for each of the remaining skills in the skill gap S_{g} for the employee. Thereafter, the processor 202 may recommend the one or more third skills from the skill gap S_{g} based on at least the motivational factor. Similarly, the processor 202 may recommend the one or more third skills to each of the one or more remaining employees.

### Collaborative Filtering Based Recommendation:

The collaborative filtering based recommendation may utilize past preferences of the employee to recommend the one or more third skills to the employee. For example, consider an employee-skill matrix M, where m_{i,j}={0,1} represents whether an employee i (i=1 to Nₑ) possess a skill j (j=1 to N_{S}). Consider a vector Vₑᵢ, which represents a normalized preference factor for each skill for the employee i. Consider another vector αᵢ comprising N_{S} values, where each index may represent whether or not the employee i possess the corresponding skills. The value of each index in αᵢ may be either “0” or “1”. The processor 202 may utilize the following equation to determine a recommendation vector RE:

RE=α₁*(M^{T}*M)*Vₑᵢ (2)

wherein,

RE is a vector of N_{S} values, wherein each value represents a recommendation factor for each skill j for each employee i.

Post determining the personalized and the popular recommendations of the one or more third skills corresponding to each of the one or more employees, the processor 202 may recommend the personalized and the popular recommendations to the one or more employees. The processor 202 may present a GUI to each of the one or more employees, where the GUI may display the personalized and the popular recommendations. The one or more employees may utilize the GUI to provide the input pertaining to the selection of the one or more fourth skills.

In another embodiment, the processor 202 may utilize the training recommender device 214 to recommend the one or more third skills to the one or more employees based on a combination of the constructive theory of learning and the motivational theory of learning. For example, the training recommender device 214 determines that an employee may learn skills such as C++, Java, and Haskell in 3 days, 5 days, and 7 days, respectively. Further, the training recommender device 214 determines that a motivational factor for each skill (C++, Java, and Haskell) is 0.7, 0.5, and 0.9, respectively. Thereafter, the training recommender device 214 may recommend the skills to the employee based on the time effort of each skill in conjunction with the motivational factor of each skill. The training recommender device 214 may first normalize the time effort using standard normalization techniques. For example, a time effort may be normalize using following equation:

$$normalized value = \frac{\begin{matrix}time effort ( in days ) for a skill * \\ days in current month\end{matrix}}{days in year} \qquad ( 3 )$$

In such a case, 3 days is normalized as 0.2465, 5 days is normalized as 0.4109, and 7 days is normalized as 0.5753. Thereafter, the training recommender device 214 may perform one or more mathematical and logical operations on the normalized value of the each skill and the motivational factor of the each skill to determine a recommendation score for the each skill. For example, a recommendation score for C++ skill is determined as 0.2465*0.7=0.1725. Similarly, a recommendation score for Java skill is determined as 0.2045 and a recommendation score for Haskell skill is determined as 0.5177. Thereafter, the training recommender device 214 may recommend the skills (C++, Java, and Haskell) based on the recommendation score associated with each of the C++, Java, and Haskell skills. In such a case, the training recommender device 214 may assign a high priority to Haskell skill, a medium priority to Java skill, and a low priority to C++ skill.

At step 308, the input is received from the one or more employees. In an embodiment, the processor 202 may receive the input from the employee computing device 104. The input may be indicative of the selection of the one or more fourth skills from the one or more third skills. Post the recommendation of the one or more third skills, each of the one or more employees may view the one or more recommended third skills (personalized and popular) on the GUI of the employee computing device 104. Thereafter, each employee may select the one or more fourth skills from the recommended one or more third skills.

Further, each employee may assign the priority to each of the one or more fourth skills based on at least one of his/her preferences, availability, and scope of the one or more fourth skills in the future. Post selecting the one or more fourth skills, the each employee may request for the one or more trainings corresponding to the each of the one or more fourth skills. In an embodiment, the priority of the one or more trainings may be based on at least the priority of the one or more fourth skills. For example, an employee selects two skills C# and Haskell. The employee assigns a high priority to Haskell skill and a medium priority to C# skill. In such a case, the processor 202 may assign (or consider) the high priority to one or more trainings pertaining to the Haskell skill and the medium priority to the one or more trainings pertaining to the C# skill.

Post receiving the requests for the one or more trainings from the one or more employees, the processor 202 may transmit the requests to the user such as the supervisor or the manager.

At step 310, the GUI is presented to the supervisor, wherein the GUI displays the one or more trainings requested by the one or more employees. In an embodiment, the processor 202 may present the GUI to the supervisor, the project manager, or the manager. The supervisor may utilize the GUI to view the one or more trainings requested by the one or more employees. Further, the supervisor may view the one or more attributes (e.g., the previous appraisal ratings, the salary details, the performance of the employee on the one or more previous projects) associated with the one or more employees. Thereafter, the supervisor may approve or reject the one or more trainings requested by each employee based on at least one or more factors such as, but not limited to, a cost incurred by the organization for training the employee, a cost incurred by the organization when the employee is non-utilizable, and a cost incurred by the organization for hiring one or more new employees having the one or more third skills. For example, an employee has requested for a training associated with a Haskell skill. A cost incurred by an organization for training the employee is 1000 USD. A cost incurred by the organization when the employee is not utilized in future is 1200 USD. A cost incurred by the organization for hiring a new employee having Haskell skill is 2500 USD. Therefore, a cost incurred by the organization when the organization decides to train the employee is 2200 USD. Further, a cost incurred by the organization when the organization decides to hire a new employee is 2500 USD. In such a case, a supervisor may approve the training for the employee. Similarly, the supervisor may approve or reject the one or more trainings requested by the remaining one or more employees. The one or more trainings requested by the one or more employees, who have been approved by the supervisor, has been referred to as one or more filtered trainings.

A person having ordinary skill in the art will understand that the scope of the disclosure is not limited to above mentioned factors based on which the supervisor may provide his/her approval. In an embodiment, the supervisor may provide approval based on various other factors such as a time duration associated with the one or more trainings, his/her own preference for the one or more employees, past performances of the one or more employees, and so on. For example, an employee has requested for a training associated with a C++ skill. The time period (e.g., day, month, etc.) requested by the employee to take up the training is between 16th May 2015 and 25th May 2015. However, as per requirement of a new project, the training pertaining to C++ skill should be completed on or before 18th May 2015. The supervisor determines that the employee need at least five days to complete the training. In such a case, the supervisor may reject the training requested by the employee. In another illustrative embodiment, the supervisor may accept/reject one or more trainings requested by an employee, who he/she may prefer over other employees based on at least his/her likes/dislikes for the employee. For example, two employees such as employee-A and employee-B have requested for trainings pertaining to Oracle skill. The supervisor likes employee-A more than employee-B based on at least his/her past working experience with the employee-A, previous appraisal records of the employee-A, or other characteristics (e.g., discipline, communication skill, commitment, etc.) of the employee-A. In such a case, the supervisor may accept the trainings requested by the employee-A.

Further, in an embodiment, the processor 202 may receive the one or more filtered trainings of the one or more employees, which may have been approved by the supervisor. The processor 202 may automatically approve the one or more filtered trainings. In an embodiment, such an automatic approver may be required to increase the accuracy of managing the one or more skills and trainings of the one or more employees in the organization.

At step 312, the one or more filtered trainings of the one or more employees are approved automatically. In an embodiment, the processor 202 may utilize the training approver device 216 to approve the one or more filtered trainings of the one or more employees. The training approver device 216 may approve the one or more filtered trainings of each employee, from the one or more employees, based on at least the skill gap, the preference of the each employee for the one or more fourth skills selected form the one or more third skills, and the skill path of the one or more employees. In an embodiment, the training approver device 216 may utilize an allocation algorithm to allocate/approve the one or more filtered trainings. In an embodiment, the automatic allocation of the one or more filtered training/post approval from the supervisor, may be achieved by optimizing the following objective equation:

Input: S, E, Pᵢⱼ, αᵢⱼ, Dⱼ

Output: Mᵢⱼ

Objective:

Minimize(Σ_{iεE,jεS}Mᵢⱼ*(Pᵢⱼ+αᵢⱼ))+(Σ_{jεS}(Dⱼ−Σ_{iεE}Mᵢⱼ)*β) (4)

Constraints:

C1: Σ_{jεS} Mᵢⱼ≦1

C2: Mᵢⱼ≦Pᵢⱼ

C3: Σ_{iεE} Mᵢⱼ≦Dⱼ

Ranges:

1. Mᵢⱼε{0,1}

2. 0≦Pᵢⱼ≦|S|

3. αᵢⱼε[0,1]

wherein,

S: Set of skills that are in demand (i.e. one or more third skills);

E: Set of employees opted for new skill training;

i: Index variable to represent each employee in the set E;

j: Index variable to represent each skill in the set S;

Pᵢⱼ: Order of preference at which Employee i chose skill j. (1 is most preferred and n is least preferred.) For skills that are not preferred by Employee i, Pᵢⱼ=0;

αᵢⱼ: Normalized factor representing ability of Employee i in learning skill j;

Mᵢⱼ: Indicator variable indicating skill j is allotted to employee i;

Dⱼ: Demand for skill j; and

β: Penalty factor for missing a skill demand. It has to be at least twice that of |S| (if not there maybe scenario in which system may allocate one person to his best preference and the other may be left unallocated, instead of allocating two employees to their last preference).

In an embodiment, the objective equation (i.e., equation 4) ensures that each employee may get a most preferred skill and each skill may be allocated to the one or more employees who may learn the skill easily. The objective equation further ensures that each skill may try to meet its demand count as much as possible. In an embodiment, the constraint C1 ensures that each employee may be allotted at most one skill. The constraint C2 ensures that a skill is not allotted to an employee unless it is one of his/her preferred skill. The constraint C3 ensures that a skill is not over-allotted.

For example, consider C++, and Oracle as a set of third skills and one employee is required for each third skill. Further, consider five employees have requested for trainings for each of C++ skill and Oracle skill. The project manager of the five employees have approved only trainings for three employees (e.g., a first employee, a second employee, and a third employee). The first employee has given a high priority to C++ skill and a medium priority to Oracle skill. The second employee has given a high priority to oracle skill and a medium priority to C++ skill. The third employee has selected only C++ skill and has given a high priority to C++ skill. Further, based on the skill path of each employee, the first employee takes 5 days to learn C++ skill and 7 days to learn Oracle skill, the second employee takes 7 days to learn C++ skill and 4 days to learn Oracle skill, and the third employee takes 2 days to learn C++ skill. In such a case, the training recommender device 214 may approve C++ trainings for the third employee and the oracle trainings for the second employee. Further, the training recommender device 214 may further take into account a number of employees required of a particular skill, while approving the trainings for the one or more employees. For example, the project manager has approved training for five employees, but only three employees are required. Therefore, the training recommender device 214 will approve trainings for only three employees out of the five employees. In an embodiment, the three employees are selected based on the skill path of each employee as described above.

In an embodiment, the objective equation (i.e., equation 4) may be solved by constructing a bipartite graph and further running a standard maximum weight matching algorithm (e.g., Hungarian algorithm) on the bipartite graph in polynomial time. For example, the processor 202 may generate a bipartite graph comprising a first partition and a second partition. The first partition may include |E| nodes and the second partition may include |S|(Σ_{jεS} Dⱼ) nodes. For each skill j, the processor 202 may add Dⱼ nodes in the second partition. In an embodiment, the processor 202 may add one or more edges between an employee i and all of the Dⱼ nodes corresponding to skill j, when the employee i may prefer the skill j. Each of the one or more edges may be associated with a weight, which may be equal to β−Pᵢⱼ−αᵢⱼ. Thereafter, the processor 202 may utilize the Hungarian algorithm to determine the maximum weight matching in the bipartite graph.

FIGS. 4A-4E are example graphical user interfaces (GUIs) that may be presented to an user or an employer on a display screen of a computing device such as the user computing device 102 or the employee computing device 104. The user may correspond to one or more of, but not limited to, the supervisor, the manager, the project manager, the resource manager, or the staffing manager.

FIG. 4A is a block diagram illustrating a GUI 400A displaying skill gap in an organization, in accordance with an embodiment. The GUI 400A may be displayed on a display screen of a computing device such as the user computing device 102. The user such as the resource manager or the staffing manager logs into a skill managing environment 402 using his/her user id and password. The processor 202 may present the GUI 400A to the staffing manager, when the staffing manager may have logged in. The staffing manager may click on a tab such as 404A, 404B, and 404C to view skill requirements over next 3 months, 6 months, and 1 year, respectively, as shown in FIG. 4A. Thereafter, the staffing manager may utilize the GUI 400A to view available skills (depicted by 406), required skills (depicted by 408), shortage skills (depicted by 410) and surplus skills (depicted by 412). The GUI 400A further displays a number of employees available in the organization in different categories of skills, a shortage of employees in different categories of skills, and a number of employees who may not be utilized in future for different categories of skills. Further, the staffing manager may click on a tab such as initiate training tab 414 to initiate recommendations of the one or more third skills (i.e., the shortage skills depicted by 410).

FIG. 4B is a block diagram illustrating a GUI 400B utilized by the user to provide the one or more parameters corresponding to the one or more training, in accordance with an embodiment. The staffing manager may click on a tab such as training application due date tab 416 to input a due date by which the one or more employees must express their interest in joining the one or more trainings recommended to them. Further, the staffing manager may click on a tab such as training application notification date tab 418 to input a notification date by which the one or more employees may be notified if their request for the one or more trainings has been approved or not. The staffing manager may further click on a tab (such as tab 420) to input the number of skill shortage (i.e., number of third skills) to be filled through the one or more trainings. Thereafter, the staffing manager may click on a tab such as a start tab 422 to generate a recommendation of the one or more training, pertaining to the one or more third skills, to the one or more employees.

FIG. 4C is a block diagram illustrating a GUI 400C utilized by an employee, from the one or more employees, to select his/her preferences among the one or more third skills, in accordance with an embodiment. The GUI 400C may be displayed on a display screen of a computing device such as the employee computing device 104. The employee (e.g., ABC) logs into a skill managing environment 402 using his/her user id and password. The processor 202 may present the GUI 400C to the employee, when the employee may have logged in. The employee may utilize the GUI 400C to view and edit his/her existing skills (i.e., his/her one or more second skills). The employee may click on a tab such as add new skills tab 424 to add a skill, which he/she may have learnt/mastered. The employee may further view and edit status of one or more ongoing/completed trainings. The employee may click on a tab such as add new learning tab 426 to add a new training/learning. Further, the employee may view the recommendations (personalized and popular) of the one or more third skills. The processor 202 further displays a skill path for each of the one or more third skills based on his/her existing skills (i.e. the one or more second skills). The employee may select the one or more fourth skills from the one or more third skills based on at least his/her preferences and/or the skill path. Further, the employee may assign a priority to each of the one or more fourth skills. Further, the employee may click on a tab such as preferred training dates tab 430 to input a preferred time period for undergoing the one or more requested trainings. Thereafter, the employee may click on a tab such as a submit tab 432 to submit a request for the one or more trainings corresponding to the one or more fourth skills.

After the employee has provided his/her preference, the request may go to his/her supervisor or manager or project manager for further approval. The processor 202 may present a GUI 400D to the manager. The GUI 400D may present information such as name of the employee, previous appraisal details, one or more requested trainings, preferred dates, and cost. The GUI 400D may further present other information such as a training cost, a cost incurred when the employee is not utilized, and a cost of hiring a new employee. The manager may utilize the information presented on the GUI 400D to approve or reject the one or more requested trainings of the one or more employees. The manager may click on a tab such as a approve tab 434 to approve the one or more requested trainings. The manager may click on a tab such as a reject tab 436 to reject the one or more requested trainings.

Post approval from the manager, the processor 202 or the training approver device 216 may automatically approve the one or more trainings requested by the one or more employees, which have been approved by the manager. The automatic approver is based on at least the skill gap, the preference of each employee for the one or more fourth skills selected form the one or more third skills, and the skill path of the one or more employees. While approving the one or more requested trainings, the processor 202 or the training approver device 216 ensures that each employee may get a most preferred skill, each skill may meet its demand count as much as possible, and each skill may be allocated to the one or more employees who may learn the skill easily. Thereafter, the one or more requested trainings of the one or more employees approved by the processor 202 or the training approver device 216 are presented to the staffing manager or the resource manager. The processor 202 may present a GUI 400E to the resource manager. The GUI 400E may display the number of employees who have requested the trainings pertaining to the one or more third skills. The GUI 400E further displays the number of approved training requests and the number of rejected training requests. The resource manager may click on a tab such as edit tab to view the view the names and skills of the employees whose training requests may have been approved or rejected. The resource manager may further click on a edit tab to manually modify one or more approvals/rejections. The resource manager may further modify the training period. The resource manager may click on a tab such as a approve tab 438 to finalize the training requests of the one or more employees.

Post approval from the resource manager, the one or more employees may view status of their respective training requests and the corresponding training dates.

Various embodiments of the disclosure lead to a method and a system for training management in an organization. The disclosed method and system manages one or more skills of one or more employees in the organization based on one or more upcoming projects. The disclosed method and system utilizes a constructive theory of learning and a motivational theory of learning to recommend the one or more skills to the one or more employees. Further, the disclosed method and system automatically approves one or more trainings pertaining to the one or more skills required for processing the one or more upcoming projects. Further, the disclosed method and system ensures that each employee may get his/her most preferred one or more trainings. The one or more trainings, taken up by the one or more employee post approval, may facilitate retention and growth of the one or more employees in the organization. Further, the one or more trainings may facilitate a wider job opportunity in outside world.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for training management in an organization have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for training management in an organization, said method comprising:
determining, by one or more processors, a skill gap in said organization based on at least one or more first skills required for processing one or more upcoming projects, and one or more second skills possessed by one or more employees in said organization, wherein said skill gap comprises one or more third skills, which are deficient in said organization;
determining, by said one or more processors, a skill path for each of said one or more employees based on at least said skill gap and said one or more second skills;
recommending, by said one or more processors, one or more third skills to an employee, from said one or more employees, based on at least said skill path associated with said employee; and
approving, automatically by said one or more processors, one or more trainings corresponding to at least one skill, from said one or more third skills, for said employee based on at least said skill gap, a preference of said employee for said one or more third skills, and said skill path of said one or more employees.

2. The method of claim 1 further comprising recommending, by said one or more processors, said one or more trainings to said employee based on at least a motivational factor associated with said one or more third skills for said employee, wherein said motivational factor is determined based on at least a first count of employees having said one or more second skills and a second count of employees having said one or more second skills and said one or more third skills.

3. The method of claim 1 further comprising receiving, by said one or more processors, an input from said employee, wherein said input is indicative of selection of one or more fourth skills, from said one or more third skills, by said employee, wherein said selection of said one or more fourth skills corresponds to said preference of said employee.

4. The method of claim 3, wherein said input further comprises receiving at least a priority assigned to each of said one or more fourth skills.

5. The method of claim 4 further comprising receiving, by said one or more processors, a request for said one or more trainings corresponding to each of said one or more fourth skills based on at least said assigned priority.

6. The method of claim 5 further comprising presenting, by said one or more processors, a graphical user interface (GUI) to a supervisor, wherein said GUI displays at least said one or more trainings requested by said employee to said supervisor.

7. The method of claim 6, wherein said supervisor approves said one or more requested trainings based on at least one or more of a cost incurred by said organization for training said employee, a cost incurred by said organization when said employee is non-utilizable, and a cost incurred by said organization for hiring one or more new employees with said one or more third skills.

8. The method of claim 7 further comprising approving, automatically by said one or more processors, said one or more requested trainings of said employee based on at least said approval by said supervisor.

9. A system for training management in an organization, said system comprising:
one or more processors configured to:
determine a skill gap in said organization based on at least one or more first skills required for processing one or more upcoming projects, and one or more second skills possessed by one or more employees in said organization, wherein said skill gap comprises one or more third skills, which are deficient in said organization;
determine a skill path for each of said one or more employees based on at least said skill gap and said one or more second skills;
recommend one or more third skills to an employee, from said one or more employees, based on at least a motivational factor associated with said one or more third skills for said employee; and
approve automatically one or more trainings corresponding to at least one skill, from said one or more third skills, for said employee based on at least said skill gap, a preference of said employee for said one or more third skills, and said skill path of said one or more employees.

10. The system of claim 9, wherein said one or more processors are configured to determine said motivational factor based on at least a first count of employees having said one or more second skills and a second count of employees having said one or more second skills and said one or more third skills.

11. The system of claim 10, wherein said one or more processors are further configured to determine said first count of employees and said second count of employees based on at least information extracted from at least one or more online professional networks and collaborative workspaces.

12. The system of claim 9, wherein said one or more processors are further configured to recommend said one or more trainings to said employee based on at least said skill path associated with said employee.

13. The system of claim 9, wherein said one or more processors are further configured to receive an input from said employee, wherein said input is indicative of selection of one or more fourth skills, from said one or more third skills, by said employee, wherein said selection of said one or more fourth skills corresponds to said preference of said employee.

14. The system of claim 13, wherein said input further comprises receiving at least a priority assigned to each of said one or more fourth skills.

15. The system of claim 14, wherein said one or more processors are further configured to receive a request for said one or more trainings corresponding to each of said one or more fourth skills based on at least said assigned priority.

16. The system of claim 15, wherein said one or more processors are further configured to present a graphical user interface (GUI) to a supervisor, wherein said GUI displays at least said one or more trainings requested by said employee to said supervisor.

17. The system of claim 16, wherein said supervisor approves said one or more requested trainings based on at least one or more of a cost incurred by said organization for training said employee, a cost incurred by said organization when said employee is non-utilizable, and a cost incurred by said organization for hiring one or more new employees with said one or more third skills.

18. The system of claim 17, wherein said one or more processors are further configured to approve said one or more requested trainings of said employee based on at least said approval by said supervisor.

19. A computer program product for use with a computer, the computer program product comprising a non-transitory computer readable medium, wherein the non-transitory computer readable medium stores a computer program code for training management in an organization, wherein the computer program code is executable by one or more processors to:
determine a skill gap in said organization based on at least one or more first skills required for processing one or more upcoming projects, and one or more second skills possessed by one or more employees in said organization, wherein said skill gap comprises one or more third skills, which are deficient in said organization;
determine a skill path for each of said one or more employees based on at least said skill gap and said one or more second skills;
recommend one or more trainings, corresponding to each of said one or more third skills, to an employee, from said one or more employees, based on at least a motivational factor associated with said one or more third skills for said employee; and
approve automatically said one or more trainings of at least one skill, from said one or more third skills, for said employee based on at least said skill gap, a preference of said employee for said one or more third skills, and said skill path of said one or more employees.
